(19) United States
(12) Patent Application Publication
(10) Pub. No.: US 2023/0186324 A1
(43) Pub. Date: Jun. 15, 2023

(54) METHOD AND SYSTEM FOR IDENTIFYING A TIMEPIECE

(71) Applicant: The Swatch Group Research and Development Ltd, Marin (CH)

(72) Inventor: Jean-Luc BAZIN, Tuescherz-Alfermee (CH)

(73) Assignee: The Swatch Group Research and Development Ltd, Marin (CH)

(21) Appl. No.: 18/051,608

(22) Filed: Nov. 1, 2022

(30) Foreign Application Priority Data
Dec. 10, 2021 (EP) 21213764.0

(51) Int. Cl. G06Q 30/018; G06T 7/00

(52) U.S. Cl. CPC G06Q 30/0185; G06T 7/0002

(57) ABSTRACT

A system for authenticating a timepiece including an electronic device including an interface for the visual and/or sound broadcasting of information and an image acquisition module, as well as a server including a database including reference digital identifying elements, the system including a wireless and/or wired network architecture connecting the electronic device to the server.

### TECHNICAL FIELD OF THE INVENTION

The invention relates to a method and a system for identifying/authenticating a timepiece using an electronic device.

The invention further relates to a computer program comprising program code instructions for executing the steps of this method.

### TECHNOLOGICAL BACKGROUND

In order to be able to authenticate/identify a timepiece such as a mechanical or electro-mechanical watch, the timepiece can be provided with an identification mark, in particular as part of the manufacturing process thereof. This identification mark can take the form of a coding applied, for example, to an outer part of the case of this timepiece that is not directly visible when the timepiece is being worn on the wrist so as not to detract from the aesthetics of said timepiece. This coding can be, for example, a coded image, such as a two-dimensional bar code as defined in the European patent application No. 1 804 195 A1. This coded image, which is obtained by specific calculation algorithms, is based on the identifier of the timepiece, which is typically sold with a card containing said timepiece identifier.

However, one of the main drawbacks is that a specific computer device must be used in order to be able to authenticate said timepiece, which is time-consuming and complicated. More specifically, this code can only be decrypted by a decryption operation using decryption keys provided by the parent company.

It is understood that there is a need to find an alternative solution that in particular overcomes the drawbacks of the prior art.

### SUMMARY OF THE INVENTION

One of the purposes of the present invention is to overcome all or part of the aforementioned drawbacks by providing a method and a system that helps to identify/authenticate timepieces with certainty.

Another purpose of the present invention is to propose an identification/authentication method that is simple, reliable and robust.

To this end, the invention relates to a method for authenticating a timepiece using an electronic device comprising an interface for the visual and/or sound broadcasting of information and an image acquisition module, the method comprising the following steps:
generating, via a processing unit of the electronic device, a digital identifying element from descriptive features of a digital graphical representation of the timepiece, said step comprising:
   a sub-step of elaborating said descriptive features of the digital graphical representation including a phase of identifying various graphical objects contained in at least one area of interest of said graphical representation, said area of interest containing a structural and/or aesthetic defect of said timepiece;
   a sub-step of creating the digital identifying element from said descriptive features of the various identified graphical objects with the exception of a descriptive feature for the structural and/or aesthetic defect contained in said at least one area of interest of the graphical representation;
broadcasting, on the broadcasting interface of the electronic device, an identification code of the brand and/or the serial number of the timepiece so as to provide visual and/or audible authentication information for said timepiece if the validity of the generated digital identifying element is confirmed during a sub-step, implemented by a control unit of a server, of comparing the generated digital identifying element with a reference digital identifying element for the timepiece, said reference digital identifying element having been created beforehand by a device for generating such a unique reference digital identifying element for the timepiece.

According to other embodiments:
said generating step implemented by the processing unit of the electronic device comprises a sub-step of designing a digital graphical representation of the timepiece including a phase of acquiring, by the acquisition module of the electronic device, at least one image of all or part of the timepiece;
the sub-step comprises a phase of applying identifying-element design algorithms to said descriptive features of the various identified graphical objects, with the exception of the descriptive feature for the structural and/or aesthetic defect;
during the phase, the processing unit of the electronic device, by executing these algorithms, performs a selection of the descriptive features, with the exception of the descriptive feature for the structural and/or aesthetic defect, which are located on the graphical representation at the periphery of the descriptive feature for the structural and/or aesthetic defect;
during the phase, the processing unit of the electronic device, by executing these algorithms, performs a selection of the descriptive features, with the exception of the descriptive feature for the structural and/or aesthetic defect, which are located on the graphical representation in an area surrounding the descriptive feature for the structural and/or aesthetic defect, the width L whereof can be configured beforehand;
a reference area of interest and said area of interest each form a part of the external parts of the timepiece comprised/illustrated on/in the graphical representation, this area containing said structural and/or aesthetic defect;
the area of interest is similar to a reference area of interest for said timepiece which is archived in a database of the server.

The invention further relates to a system for authenticating a timepiece comprising an electronic device, a generating device and a server implementing said method, the electronic device comprising an interface for the visual and/or sound broadcasting of information and an image acquisition module, and the server comprising a database comprising reference digital identifying elements, the system comprising a wireless and/or wired network architecture connecting the electronic device to said server.

Advantageously, the generating device is capable of contributing to the creation of reference digital identifying elements for timepieces.

The invention further relates to a computer program comprising program code instructions for executing the steps of this method when said program is executed by the control unit and the processing units respectively of the server and of the electronic and generating devices of the system.

### BRIEF DESCRIPTION OF THE FIGURES

Other features and advantages of the present invention will become more apparent from the following description, given with reference to the accompanying figures listed below:

FIG. 1 is a diagrammatic view of a system for authenticating/identifying a timepiece using an electronic device comprising an interface for the visual and/or sound broadcasting of information and an image acquisition module, according to one embodiment of the invention, and

FIG. 2 is a flow chart relating to a method for authenticating/identifying this timepiece according to one embodiment of the invention.

### DETAILED DESCRIPTION OF THE INVENTION

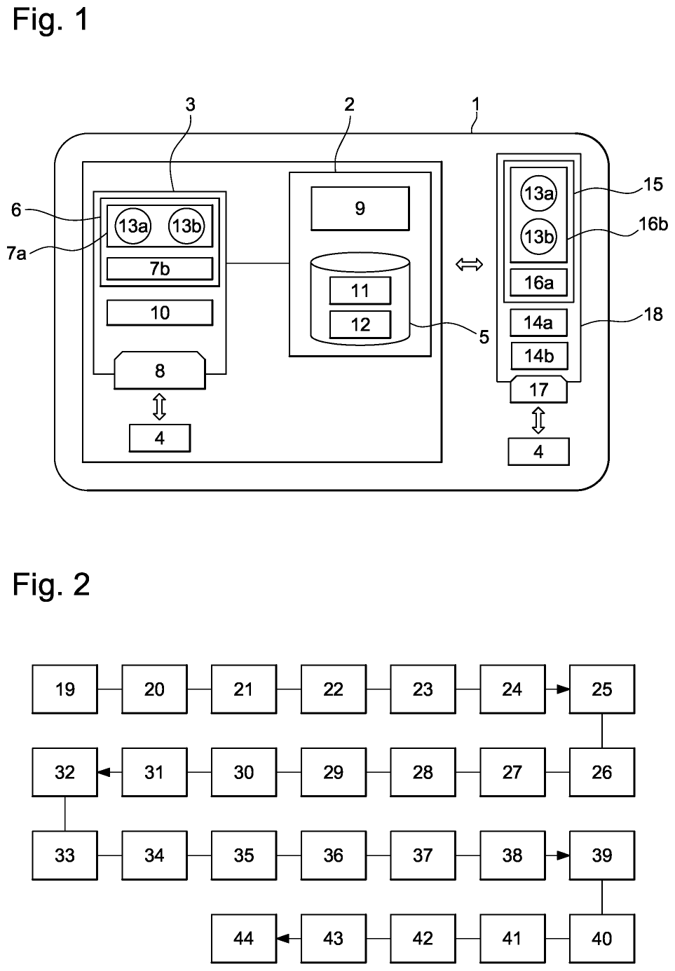

FIG. 1 shows a diagrammatic view of the system 1 for authenticating/identifying a timepiece 4 using an electronic device 18 comprising an interface 14b for the visual and/or sound broadcasting of information and an image acquisition module 17. It is thus understood that such a system 1 allows said timepiece 4 to be authenticated/identified in particular using an electronic device 18.

In the present embodiment of the invention, such a timepiece 4 is preferably a mechanical watch. However, in an alternative embodiment, it can be an electronic or electro-mechanical watch.

Such a system 1 thus comprises the timepiece 4, the electronic device 18, a device 3 for generating a unique reference digital identifying element 11 for the timepiece 4 and a server 2. This system 1 further comprises a wireless and/or wired network architecture connecting the generating device 3 and the electronic device 18 with the server 2.

As mentioned hereinabove, such a system 1 allows for transactional exchanges requiring the timepiece 4 to be authenticated. More specifically, the transactional exchange is implemented by the electronic device 18 which, during this exchange, participates in authenticating the timepiece 4 by generating an identifying element for this timepiece 4, the validity whereof is then checked against the reference identifying element 11 corresponding to this timepiece 4. In this context, this system 1 is also able to implement the process of creating the reference identifying element 11 which is unique.

This reference identifying element 11 is unique because it originates from particular and specific visual and structural features of the timepiece 4. These features are specific to each timepiece 4 even if they belong to the same model of a similar brand. More specifically, between timepieces of the same model and of a similar brand, there are, for example, structural and/or aesthetic differences which are visible, and even more so on a macroscopic scale, and which result, for example, from the manufacturing processes of the watch components making up these timepieces 4 or from the operations for assembling these components together to design these timepieces 4.

In this system 1, the server 2 includes a database 5 archiving in particular the reference digital identifying elements 11 of timepieces 4 that have been created. Each reference identifying element 11 is archived in this database 5 by being associated with descriptive data 12 of the timepiece 4 to which it relates.

These descriptive data 12 comprise, in a non-limiting and non-exhaustive manner;
the graphical representation of the timepiece 4 from which the reference identifying element 11 is generated;
data regarding at least one reference area of interest selected in the graphical representation and from which the reference identifying element 11 is generated;
one or more captured images of this timepiece 4 used to generate the reference identifying element 11;
sensitive information data regarding the timepiece:
   the brand identification code for this timepiece 4;
   a serial number to authenticate the timepiece 4;
   the reference of the model of this timepiece 4;
   the technical data for this timepiece 4;
etc.

In this server 2, the control unit 9 comprises hardware and software resources, in particular at least one processor cooperating with memory elements. This control unit 9 is capable of executing instructions for implementing a computer program aimed at, for example, managing the database 5 of the server 2 and/or processing requests/instructions/data from/to the generating device 3 or from/to the electronic device 18 participating in a process for authenticating the timepiece 4.

It should be noted that the control unit 9 is connected to the generating device 3 and to the electronic device 18 via a communication unit of the server 2. Such a communication unit is capable of implementing secure communication protocols within the network architecture of this system 1.

In this system 1, the electronic device 18 can be, for example, a computer, a smartphone, a tablet, or an electronic terminal, in particular a payment terminal. Such an electronic device 18 comprises, in a non-limiting or non-exhaustive manner:
a processing unit 15 including hardware and software resources, in particular at least one processor 16a cooperating with memory elements 16b;
the visual broadcast interface (for example a screen) and/or sound broadcast interface 14b (for example a loudspeaker) for broadcasting information;
a communication interface 14a for establishing a communication link between the processing unit 15 thereof and the control unit 9 of the server 2 for exchanging data;
a selection interface such as a keypad or even a touch-sensitive interface comprised, for example, in the broadcast interface 14b comprising a screen;
at least one audio stream capture module comprising at least one microphone;
the image acquisition module 17, also referred to as the module for capturing at least one image, comprising in particular an image sensor of the CCD (Charged Coupled Device) or CMOS (Complementary Metal-Oxide-Semiconductor) matrix sensor type for example, and
a man-machine interface MMI.

In this electronic device 18, the processing unit 15 is connected, inter alia, to the image acquisition module 17, to the broadcast interface 14b, to the communication interface, to the selection interface and to the man-machine interface MMI. This processing unit 15 is in particular capable of executing instructions for implementing the computer program aimed at, for example, processing the requests/instructions/data from/to the server 2, in particular from/to the control unit 9 thereof.

In this system 1, the device 3 for generating the unique reference digital identifying element 11 comprises, in a non-limiting and non-exhaustive manner:
a processing unit 6 including hardware and software resources, in particular at least one processor 7b cooperating with memory elements 7a;
a module 8 for capturing at least one image regarding the timepiece 4;
a communication module 10 which is capable of implementing secure communication protocols within the network architecture of this system 1, in particular to exchange data with the server 2;
a man-machine interface MMI that can in particular be operated by an operator in order to configure same.

In this generating device 3, the processing unit 6 is capable of implementing:
digital image processing algorithms 13a which are intended to be applied to said at least one image regarding the timepiece 4, and
identifying-element design algorithms 13b which are applied to graphical objects extracted from said at least one image, in particular from the graphical representation for the timepiece 4.

It should be noted that the processing unit 15 of the electronic device 18 is capable of implementing the same algorithms 13a, 13b in order to generate an identifying element that is similar to the reference identifying element 11.

In this generating device 3, the capture module 8 comprises at least one photographic sensor including in particular an image sensor of the CCD (Charged Coupled Device) or CMOS (Complementary Metal Oxide Semiconductor) matrix sensor type for example.

With reference to FIG. 2, this system 1 implements a method for authenticating/identifying the timepiece 4 using the electronic device 18 comprising the interface 14b for the visual and/or sound broadcasting of information and the image acquisition module 17.

For this purpose, this method comprises a preliminary step 19 of creating the unique reference digital identifying element 11 for the timepiece 4. This creation step 19 comprises a sub-step 20 of capturing at least one image of all or part of the timepiece 4. Such a sub-step 20 is implemented by the generating device 3 and in particular by the processing unit 6 thereof. In this sub-step 20, the timepiece 4 is arranged on a support of this device 3 and the processing unit 6 thus controls said at least one photographic sensor in order to capture at least one image of this timepiece 4.

Next, this preliminary step 19 of the method provides for carrying out a sub-step 21 of digitally processing said at least one captured image comprising a graphical representation of all or part of the timepiece 4. This sub-step 21 is implemented by the processing unit 6, which includes, in the memory elements 7a thereof, the digital image processing algorithms 13a.

Such a sub-step 21 comprises in particular a phase 22 of selecting at least one reference area of interest of said graphical representation containing a structural and/or aesthetic defect, said areas serving as a basis for the design of the unique identifying element 11.

In the present embodiment, each reference area of interest forms a part of the external parts of the timepiece 4 comprised/illustrated on/in the graphical representation, this area containing this structural and/or aesthetic defect. It should be recalled that the external elements of such a timepiece 4 are all of the constituent parts that surround its movement, thus giving this timepiece 4 its aesthetics and its style, while also allowing all of its functions to be indicated. Within the context of the invention, the reference area of interest can be an external element mentioned hereinbelow in a non-limiting and non-exhaustive manner: a dial which can comprise apertures with time indications, hands, a crystal, a flange, a bezel, one or more buttons, a crown, a bracelet, a case back or a middle of this timepiece 4. Alternatively, this reference area of interest contained in the graphical representation can comprise a plurality of parts of external elements assembled together. In yet another alternative, this reference area of interest can be a part of an external element.

As mentioned, each selected reference area of interest contains at least one structural and/or aesthetic defect. Such a defect can be:
a circular defect on/in the surface of the area of interest such as a bubble, or a clump of material, etc.
a linear or stretched defect on/in the surface of the reference area of interest such as an abrasion spot, scratches, lines, or residue, etc.
a structural defect of/in the reference area of interest such as a deformation, an abnormal gap between two elements present in/on the surface of this area, or a protrusion, etc.

It should be noted that these defects belong to those that were generated by manufacturing or assembly tools or methods concerning this reference area of interest.

Once the reference area of interest has been selected, the processing sub-step 21 then provides for implementing an identification phase 23 for identifying the various graphical objects contained in this reference area of interest. In this context, the graphical objects can be, in a non-limiting and non-exhaustive manner:
appliques, indexes and symbols;
an opening such as an aperture or a recessed part of the dial making part of the movement visible (the case of a skeleton watch);
elements or a graphical representation visible within this opening;
a two- or three-dimensional graphical element of an inscription present on the face of the dial, of the crystal, of the middle, of the bezel, of the back or of the flange, for example a number, a letter or a symbol;
an ornamental element such as a precious stone;
a plate constituting the dial and which in particular carries the appliques and comprises the one or more apertures of this dial;
the crown and/or the button;
etc.

The processing sub-step 21 then comprises a phase 24 of extracting descriptive features of this graphical representation, in particular of each of the graphical objects identified.

These descriptive features define in particular the visual/aesthetic look/appearance of each graphical object. In this context, these descriptive features comprise, in a non-limiting and non-exhaustive manner:
a shape of the graphical object constituting the digital graphical representation, this shape can be a geometric shape such as a circle, sphere, ellipse, cone, cylinder, frustum, triangle, polyhedron, or a combination of at least two different or similar geometric shapes, etc.;
dimensions of the graphical object constituting the digital graphical representation, these dimensions can correspond to a thickness, a width, a length, a depth, a surface, or a volume, etc.;
one or more colours present on the one or more visible faces of the graphical object;
the structural and/or aesthetic defect;
a relative position between two or more graphical objects when the graphical representation contains a plurality of such objects.

The extracted descriptive features are then stored in the memory elements 7a of the processing unit 6 of the generating device 3.

The preliminary step 19 of the method then comprises a sub-step 25 of generating the reference digital identifying element 11 from said extracted descriptive features with the exception of the descriptive feature for the structural and/or aesthetic defect contained in said at least one reference area of interest. This sub-step 25 is implemented by the processing unit 6, which includes, in the memory elements 7a thereof, the identifying-element design algorithms.

This generating sub-step 25 comprises a phase 26 of applying, to said extracted descriptive features, with the exception of the descriptive feature for the structural and/or aesthetic defect contained in said at least one reference area of interest, the identifying-element design algorithms 13b. During this phase 26, the processing unit, by executing these algorithms, selects the extracted descriptive features, with the exception of the descriptive feature for the structural and/or aesthetic defect contained in said at least one reference area of interest, that are located in the graphical representation:
at the periphery of the descriptive feature for the structural and/or aesthetic defect, or
in an area surrounding the descriptive feature for the structural and/or aesthetic defect, the width L whereof can be configured beforehand. This width corresponds to the distance between the two opposite edges of this preferably circular area.

The method then provides for a step 27 of storing the following in the database 5 of the server 2:
this reference identifying element 11;
the graphical representation of the timepiece 4 from which this identifying element 11 is generated;
data regarding said at least one reference area of interest selected in the graphical representation and from which the identifying element 11 is generated;
one or more captured images of this timepiece 4 used to generate the graphical representation.

The method then provides, as part of the authentication/identification of the timepiece 4, a step 28 of generating a digital identification element from descriptive features of a digital graphical representation of the timepiece 4. It should be noted that such a step 28 is implemented by the electronic device 18 and in particular by the processing unit 15 thereof.

This generating step 28 comprises a sub-step 29 of arranging the timepiece 4 in the vicinity of the electronic device 18. More particularly, this sub-step 29 provides for a phase of positioning 30 the timepiece 4 facing the image acquisition module 17 of this device 18. More specifically, during this phase 30, the case of the timepiece on the dial side and/or the back side as well as all or part of the bracelet are arranged facing this acquisition module 17.

This step 28 of the method then comprises a sub-step 31 of designing a digital graphical representation of the timepiece 4. This sub-step 31 includes a phase of acquiring 32, using the acquisition module 17 of the electronic device 18, at least one image of all or part of the timepiece 4. In this sub-step 31, the processing unit 15 then controls said at least one photographic sensor in order to capture at least one image of this timepiece 4.

Subsequently, the generating step 28 comprises a sub-step of elaborating 33 descriptive features of the digital graphical representation including an identification phase 34 for identifying various graphical objects contained in at least one area of interest of said graphical representation. It should be noted that the area of interest allows the part of the external elements of the timepiece that comprises the structural and/or aesthetic defect to be selected, which part is to be used to design the identifying element. It should be recalled that the area of interest is a part of the external elements of the timepiece 4 that comprises the structural and/or aesthetic defect mentioned hereinabove. This graphical representation is contained in said at least one captured image of all or part of the timepiece 4. Such an elaboration sub-step 33 is implemented by the processing unit 15 of the electronic device 18, which includes, in the memory elements 16b thereof, the digital image processing algorithms 13a.

The sub-step 33 thus provides for implementing an identification phase 35 for identifying the various graphical objects contained in this area of interest.

This elaboration sub-step 33 then comprises a phase 36 of extracting the descriptive features of the graphical objects identified in the digital graphical representation.

The generating step 28 then comprises a sub-step 37 of creating the digital identifying element from said extracted descriptive features of the various graphical objects identified in said at least one area of interest, with the exception of the descriptive feature for the structural and/or aesthetic defect contained in this area of interest. Such a creation sub-step 37 is implemented by the processing unit 15, which includes, in the memory elements 16b thereof, the identifying-element design algorithms.

This sub-step 37 comprises a phase 38 of applying, to said descriptive features, with the exception of the descriptive feature for the structural and/or aesthetic defect, the identifying-element design algorithms. During this phase 38, the processing unit, by executing these algorithms, selects the descriptive features, with the exception of the descriptive feature for the structural and/or aesthetic defect, that are located in the graphical representation:
at the periphery of the descriptive feature for the structural and/or aesthetic defect, or
in an area surrounding the descriptive feature for the structural and/or aesthetic defect, the width L whereof can be configured beforehand. This width L corresponds to the distance between the two opposite edges of this preferably circular area, or
in an area surrounding the descriptive feature for the structural and/or aesthetic defect, the area having a surface area S that can be configured beforehand. This surface area S is preferably 5 to 10 times larger than the surface area of the defect in the area of interest.

It should be noted that during this generating step, the area of interest is similar to the reference area of interest regarding said timepiece 4 which is archived in a database 5 of the server 2.

This method then comprises a step 39 of broadcasting, on the visual and/or sound communication interface 14b of the electronic device 18, an identification code of the brand and/or the serial number of the timepiece 4 to provide visual/sound authentication information for said timepiece if the generated digital identifying element is valid.

This step 39 comprises a sub-step 40 of transmitting the digital identifying element generated to the server 2. Subsequently, the broadcasting step 39 comprises a comparison sub-step 41 for checking the validity of the digital identifying element generated in the generating step 28. This sub-step 41 provides for making a comparison between the generated digital identifying element and a reference digital identifying element for the timepiece. This comparison sub-step 41, implemented by the control unit 9 of the server 2, comprises a phase of rejecting 42 the authentication/validation if the generated digital identifying element is substantially different or is different from the reference digital identifying element 11. Conversely, this comparison sub-step 41 comprises an authentication/validation approval/acceptance phase 43 if the generated digital identifying element is substantially similar or is similar to the reference digital identifying element. Following the approval/acceptance phase 43, the control unit 9 transmits a request to the database to retrieve sensitive information data regarding the timepiece, in particular the identification code of the brand and/or the serial number of the timepiece 4.

Subsequently, the broadcasting step 39 comprises a sub-step of sending 44, using the control unit 9 of the server 2, a message containing all or part of these sensitive information data, or the identification code of the brand and/or the serial number of the timepiece 4, to the electronic device 18.

As mentioned hereinabove, such an identifying element 11 is unique for each timepiece 4 and thus allows this timepiece 4 to be authenticated and/or identified.

Moreover, the invention relates to a computer program comprising program code instructions for executing the steps of this method when said program is executed by the control unit 9 and the processing units 6, 15 respectively of the server 2 and of the generating and electronic devices 3, 18.

It goes without saying that the present invention is not limited to the embodiment described hereinabove and that various simple alternatives and modifications can be considered by a person skilled in the art without leaving the scope of the invention as defined by the accompanying claims.

1. A method for authenticating a timepiece using an electronic device comprising an interface for the visual and/or sound broadcasting of information and an image acquisition module, the method comprising the following steps:
generating, via a processing unit of the electronic device, a digital identifying element from descriptive features of a digital graphical representation of the timepiece, said step comprising:
a sub-step of elaborating said descriptive features of the digital graphical representation including a phase of identifying various graphical objects contained in at least one area of interest of said graphical representation, said area of interest containing a structural and/or aesthetic defect of said timepiece;
a sub-step of creating the digital identifying element from said descriptive features of the various identified graphical objects with the exception of a descriptive feature for the structural and/or aesthetic defect contained in said at least one area of interest of the graphical representation;
broadcasting, on the broadcasting interface of the electronic device, an identification code of the brand and/or the serial number of the timepiece so as to provide visual and/or audible authentication information for said timepiece if the validity of the generated digital identifying element is confirmed during a sub-step, implemented by a control unit of a server, of comparing the generated digital identifying element with a reference digital identifying element for the timepiece, said reference digital identifying element having been created beforehand by a device for generating such a unique reference digital identifying element for the timepiece.

2. The method according to claim 1, wherein said generating step implemented by the processing unit of the electronic device comprises a sub-step of designing a digital graphical representation of the timepiece including a phase of acquiring, by the acquisition module of the electronic device, at least one image of all or part of the timepiece.

3. The method according to claim 1, wherein the sub-step comprises a phase of applying identifying-element design algorithms to said descriptive features of the various identified graphical objects, with the exception of the descriptive feature for the structural and/or aesthetic defect.

4. The method according to claim 1, wherein during the phase, the processing unit of the electronic device, by executing these algorithms, performs a selection of the descriptive features, with the exception of the descriptive feature for the structural and/or aesthetic defect, which are located on the graphical representation at the periphery of the descriptive feature for the structural and/or aesthetic defect.

5. The method according to claim 1, wherein the sub-step comprises a phase of applying identifying-element design algorithms to said descriptive features of the various identified graphical objects, with the exception of the descriptive feature for the structural and/or aesthetic defect, during the phase, the processing unit of the electronic device, by executing these algorithms, performs a selection of the descriptive features, with the exception of the descriptive feature for the structural and/or aesthetic defect, which are located on the graphical representation in an area surrounding the descriptive feature for the structural and/or aesthetic defect, the width L whereof can be configured beforehand.

6. The method according to claim 1, wherein a reference area of interest and said area of interest each form a part of the external parts of the timepiece comprised/illustrated on/in the graphical representation, this area containing said structural and/or aesthetic defect.

7. The method according to claim 1, wherein the area of interest is similar to a reference area of interest for said timepiece which is archived in a database of the server.

8. A system for authenticating a timepiece comprising an electronic device, a generating device and a server implementing the method according to claim 1, the electronic device comprising an interface for the visual and/or sound broadcasting of information and an image acquisition module, and the server comprising a database comprising reference digital identifying elements, the system comprising a wireless and/or wired network architecture connecting the electronic device to said server.

9. The system according to claim 8, wherein the generating device is capable of contributing to the creation of reference digital identifying elements for timepieces.

10. A computer program comprising program code instructions for executing the steps of the method according to claim 1, when said program is executed by the control unit and the processing units respectively of the server and of the generating and electronic devices of the system.
